(19) United States
(12) Patent Application Publication
(10) Pub. No.: US 2025/0260635 A1
(43) Pub. Date: Aug. 14, 2025

(54) NETWORK DEVICES HAVING LINK STATE TOGGLING-RESPONSIVE DAMPENERS

(71) Applicant: HEWLETT PACKARD ENTERPRISE DEVELOPMENT LP, Spring, TX (US)

(72) Inventors: Abhay Bhaskar, Bangalore (IN); Jayachandra Babu K, Bangalore (IN)

(21) Appl. No.: 18/650,387

(22) Filed: Apr. 30, 2024

(30) Foreign Application Priority Data
Feb. 13, 2024 (IN) 202441009629

(51) Int. Cl. H04L 43/16; H04L 43/0876

(52) U.S. Cl. CPC H04L 43/16; H04L 43/0876

(57) ABSTRACT

A technique includes determining that a rate at which a link state of a network interface of a network device changes violates a predetermined rate threshold. The technique includes, responsive to determining that the rate violates the predetermined rate threshold, dampening network activity associated with the network interface. The dampening includes regulating the duration of a recovery time period based on a randomly-generated time value or a pseudorandomly-generated time value. The dampening includes measuring the recovery time period and disabling the network interface responsive to the measuring of the recovery time period. The dampening includes, responsive to an end of measuring the recovery period, re-enabling the network interface.

### BACKGROUND

When a network end device powers up, the end device may exchange messages with an access device (e.g., a network switch), which allows the access device to authenticate the end device. Through its connection with the access device, the end device may communicate with entities of a local network that is affiliated with the access device, as well as communicate with entities outside of the local network.

### BRIEF DESCRIPTION OF THE DRAWINGS

FIG. 1 is a block diagram of a computer network that includes a network device having a dampening engine to dampen network activity associated with network interfaces that are subject to link state toggling bursts according to an example implementation.

FIG. 2 illustrates dampening of network activity for network interfaces according to an example implementation.

FIG. 3 is a block diagram of a dampening engine according to an example implementation.

FIG. 4 is a sequence flow diagram depicting actions taken by a network device to detect and respond to a link state toggling burst according to an example implementation.

FIG. 5 illustrates a non-transitory storage medium that stores instructions that, when executed by a network device, cause the network device to determine that a rate at which a link state of a network interface changes violates a predetermined rate threshold and dampen network activity associated with the network interface in response thereto, according to an example implementation.

FIG. 6 is a block diagram of a network device having a dampening engine to detect link state toggling bursts, and disable and re-enable network interfaces in response thereto, according to an example implementation.

FIG. 7 is a flow diagram depicting a technique detect link state toggling bursts associated with network interfaces and dampen network activity associated with the network interfaces, according to an example implementation.

### DETAILED DESCRIPTION

A wired network end device (called the “end device” herein) may be connected to a network access device through a wired communication link (e.g., a network cable or a backplane connection). The end device and the access device may each have respective physical connection endpoints, which are referred to herein as “network interfaces” (or “ports”). In an example, a network interface may be associated with a physical connector (e.g., a jack) that electrically and mechanically mates with an end connector (e.g., a plug) of a network cable.

The network interfaces at either end of a wired communication link have either respective “link up” states or respective “link down” states. When network interfaces at either end of a wired communication link have link up states, then the communication link may be active or idle. An active communication link corresponds to frames being communicated over the link. An idle communication link corresponds to the network interfaces having respective up link states, but no frames are currently being communicated over the link. A network interface may assess whether an inactive communication link is down or idle by detecting a link pulse, a particular symbol, or other idle signaling that is provided by the network interface on the other end of the link. Either network interface may transition to a link down state, which results in a link down state for the network interface at the other end of the link. A link state changing (e.g., transitioning from up to down or from down to up) is referred to herein as “toggling” the link state (or “link flapping”). A specific instance of link state toggling is referred to herein as a “toggling event” (or “link state toggling event”).

The link state of an access device's network interface is down when a wired end device that is connected to the network interface is powered down. When the end device powers up, the end device becomes available to communicate over the wired communication link, and the end device toggles the link state from down to up. This toggling event initiates a sequence of actions that, if successful, allow the end device to access the network. In an example, an access device may, responsive to an end device toggling the link state from down to up, exchange messages with the end device for purposes of authenticating the end device.

An end device passing authentication allows the end device to access services that are provided by the network. In an example, for layer 2 (L2) authentication, an access device may block dynamic host control protocol (DHCP) communications with the end device until the access device successfully authenticates the end device. Due to the blocked DHCP communications, an end device may not acquire an Internet Protocol (IP) address until the access device successfully authenticates the end device. In other examples, until the end device passes authentication, the end device may be unable to access L2 services, such as a Link Layer Discovery Protocol (LLDP)-affiliated service, a Spanning Tree Protocol (STP) service, a security-affiliated service, or other services. An end device may impose a certain time period (e.g., a DHCP timeout) for acquiring an IP address, and if the end device does not acquire an IP address within the time period, the end device may toggle the link state down and then toggle the link state up to reinitiate authentication.

An access device may be subjected to link state toggling bursts. In this context, a “link state toggling burst” refers to an excessive time-rate of toggling events at a network interface, such as a time-rate of toggling events, which exceeds a predefined time-rate threshold. A link state toggling burst may result in an access device beginning, stopping and then re-starting authentication multiple times for a particular end device within a relatively short span of time. Accordingly, a link state toggling burst may place a significant processing burden on the access device. Moreover, an access device may have a relatively large number (e.g., hundreds) of network interfaces, and multiple network interfaces of the access device may concurrently be subjected to link state toggling bursts. Accordingly, link state toggling bursts may render an access device incapable of servicing all of its network interfaces in a timely manner and may result in end devices being denied network services.

In accordance with example implementations that are described herein, a network device (e.g., an access device, such as a switch) includes a dampening engine that detects link state toggling bursts and handles the bursts in a way that reduces the processing burden that is otherwise imposed by the bursts. More specifically, in accordance with example implementations, the dampening engine monitors the network interfaces of the network device for purposes of detecting link state toggling bursts. The dampening engine, in accordance with example implementations, dampens network activity for a network interface for which a link state toggling burst has been detected. In this context, “dampening” network activity for a network interface refers to temporarily preventing or inhibiting the link state of the network interface from being toggled.

In accordance with example implementations, the dampening engine dampens network activity for a network interface by disabling the network interface for a continuous time period, which is called a “recovery window” herein. A disabled network interface has an associated link down state. Temporarily disabling a network interface that is subjected to a link state toggling burst frees up processing overhead of the network device. In this manner, the network device may temporarily ignore an end device that is producing excessive link state toggling and use its resources to service other end devices. At the end of the recovery window, the dampening engine re-enables the network interface, thereby allowing the end device to bring the link back up.

The network device may have multiple network interfaces that are concurrently subjected to link state toggling bursts. Merely disabling these network interfaces and re-enabling the network interfaces near or at the same time may be a rather ineffective way to reduce the processing burden of the network device, especially if the associated end devices continue to produce link state toggling bursts when the network interfaces of the network device are re-enabled. In accordance with example implementations, the dampening engine varies the durations of the recovery windows. Therefore, even if multiple network interfaces of the network device initially concurrently experience link state toggling bursts, the different recovery window durations spread out the re-enablements of the network interfaces in time.

There are a number of potential reasons why an end device may excessively toggle its link state. In an example, an end device may be repeatedly connected and disconnected (e.g., a network cable may be plugged and unplugged into an interface connector) from a network interface. In another example, malevolent software on one or multiple end devices may repeatedly toggle their link states in furtherance of a security attack (e.g., a denial of service (DOS) attack).

End devices may produce link state toggling bursts for more benign reasons. For example, an access device may be connected to a relatively large number (e.g., in the hundreds) of end devices that power up simultaneously or near simultaneously. The access device may be incapable of authenticating such a large number of end devices whose links go up at or near the same time. Moreover, because the end devices may have self-imposed DHCP time limits for acquiring their IP addresses, the end devices may, due to DHCP timeouts, toggle their respective link states to restart authentication, which further compounds the problem.

The dampening engine may select the recovery window durations in any of a number of different ways. In an example, the dampening engine may use a random number generator to generate, within a certain range, a number that represents the duration of the recovery window. In another example, the dampening engine may use a pseudorandom number generator to generate, within a certain range, a number that represents the duration of a recovery time window. In accordance with some implementations, lower and upper limits for recovery window may be set by configurable parameters.

The dampening engine may detect a link state toggling burst in any of a number of different ways. In an example, the dampening engine may be constructed to recognize a link state toggling burst based on a number, or count, of toggling events that occur with a time period, called a “monitoring window” herein. The monitoring window, in accordance with example implementations, is a continuous sliding, or trailing, prior time period. In an example, the monitoring window may span back in time, beginning with the current time and ending with a prior time that is offset from the current time by a time period called a “monitoring window duration” herein. The dampening engine compares the count of toggling events observed during the monitoring window to a toggling event count threshold for purposes of determining whether the toggling events correspond to a link state toggling burst. One or both of the monitoring window duration and the toggling event count threshold may be set by respective configurable parameters.

The toggling event count threshold defines a boundary between higher counts that are considered to correspond to a link state toggling burst and lower counts that are not considered to correspond to a link state toggling burst. In an example, the dampening engine determines if the count of toggling events observed during the monitoring window is greater than or equal to the toggling event count threshold, and if so, the dampening engine considers the observed toggling events to be a link state toggling burst. In another example, the dampening engine determines if the count of toggling events observed during the monitoring window is greater than the toggling event count threshold, and if so, the dampening engine considers the observed toggling events to be a link state toggling burst.

The dampening engine, in accordance with example implementations, may count toggling events of a particular type and ignore other toggling events. In an example, the dampening engine may count up-to-down link state toggling events and not count link down-to-up link state toggling events. In another example, the dampening engine may count link down-to-up link state toggling events and not count up-to-down link state toggling events. In another example, the dampening engine may count both up-to-down link state toggling events and down-to-up link state toggling events.

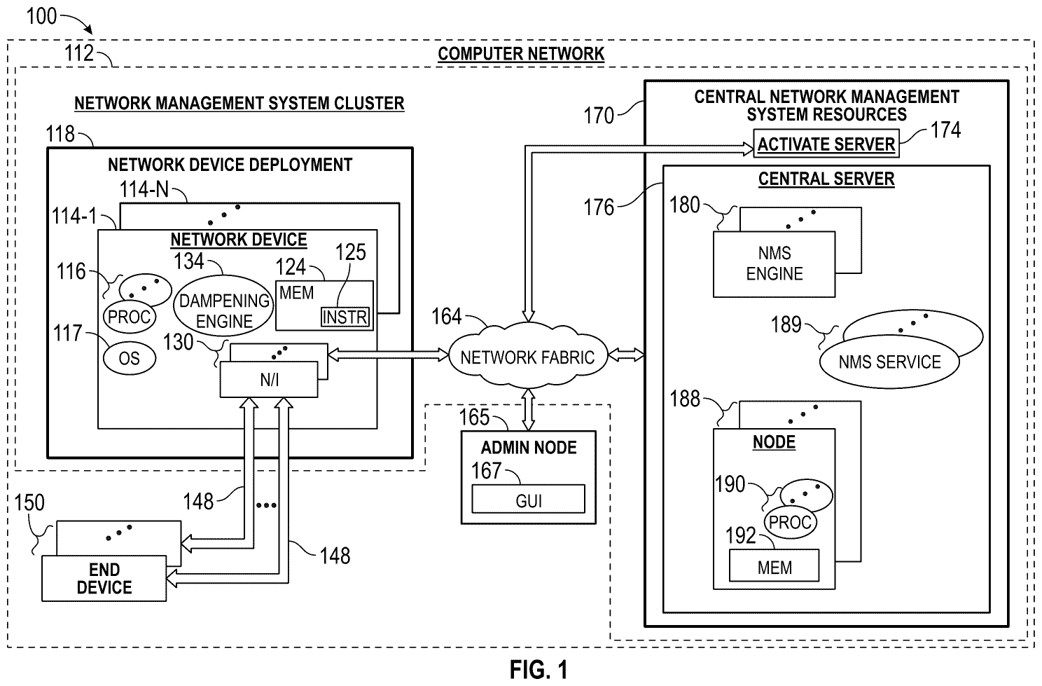

Referring to FIG. 1, as a more specific example, in accordance with some implementations, a computer network 100 includes one or multiple network management system (NMS) clusters 112. Each NMS cluster 112 includes central NMS resources 170 and one or multiple network device deployments 118. The network device deployment 118 includes managed network devices 114 that are managed by an associated NMS cluster 112. FIG. 1 depicts N network devices 114-1 to 114-N of a particular NMS cluster 112, with specific components being depicted for exemplary network device 114-1. One or multiple other network devices 114 may have similar components to network device 114-1, in accordance with example implementations.

In an example, the network device deployment 118 may correspond to a local branch network (e.g., a local area network (LAN)). In other examples, the network device deployment 118 may include multiple local branch networks. The network device deployment 118 may be associated with a particular geographical location, such as a campus site, a data center site, city, state, country or other geographical site. In accordance with some implementations, the central NMS resources 170 may be cloud-based resources that may be located in one or multiple data centers. In an example, a particular network device deployment 118 may be associated with a particular NMS customer identification (ID).

In accordance with example implementations, the network devices 114 and the central NMS resources 170 may communicate over network fabric 164. In accordance with example implementations, the network fabric 164 may be associated with one or multiple types of communication networks, such as (as examples) Fibre Channel networks, Compute Express Link (CXL) fabric, dedicated management networks, local area networks (LANs), WANs, global networks (e.g., the Internet), wireless networks, or any combination thereof.

As depicted in FIG. 1, exemplary network device 114-1 includes network interfaces 130 (or “ports”) that are connected by respective wired communication links 148 (e.g., network cables or backplane connections) to respective wired network end devices 150 (called “end devices 150” herein). The network device 114-1 may also have one or multiple network interfaces (not shown) that are connected to the network fabric 164. In examples, an end device 150 may be an Internet of Things (IoT) device, a camera, a sensor, computers, a server, a client, a laptop, printer, a scanner, a digital copier, a gaming machine, or any other processor-based device. In accordance with example implementations, the network device 114-1 may be an access device, such as a network switch.

In accordance with example implementations, the network device 114-1 includes a link state toggling burst dampener, which is referred to herein as “dampening engine 134.” The dampening engine 134, in accordance with example implementations, monitors the link states of the network interfaces 130 for purposes of detecting link state toggling bursts. The dampening engine 134 dampens or suppresses network activity for network interfaces 130 for which link state toggling bursts have been detected. In an example, the dampening engine 134 may determine whether a particular network interface 130 is being subjected to a link state toggling burst by comparing a time-rate of observed link state toggling events for the network interface 130 with a pre-defined time-rate threshold. Depending on the particular implementation, the time-rate of observed link state toggling events may be a time-rate of observed link down state-to-link up state transitions, a time-rate of observed link up state-to-link down state transitions, or a time-rate of both types of transitions.

In accordance with example implementations, the dampening engine 134 may determine a time-rate of observed toggling events for a particular network interface 130 using a trailing, or sliding, continuous time period that is referred to herein as a “monitoring window.” In an example, the monitoring window may extend back in time from the current time to a time that is offset from the current time by a monitoring window duration. Therefore, the monitoring window moves, or slides, forward in time with the current time, and the window duration corresponds to the time length of the monitoring window. In accordance with example implementations, the monitoring window duration may be a configurable parameter for the network interface 130. The dampening engine 134, in accordance with example implementations, counts the number of observed toggling events that occur (for a particular network interface 130) during the monitoring window to derive an observed toggling event count. The combination of the observed toggling event count and the monitoring window duration correspond to the time-rate of observed toggling events.

In accordance with example implementations, the combination of a toggling event count threshold and the monitoring window duration correspond to a predefined time-rate threshold. The dampening engine 134 compares the observed toggling event count for a network interface 130 to the toggling event count threshold for purposes of determining whether the network interface 130 is being subjected to a link state toggling burst. In an example, the dampening engine 134 may detect a link state toggling burst for a network interface 130 in response to the observed toggling event count for the network interface 130 being greater than or equal to the toggling event count threshold. In another example, the dampening engine 134 may detect a link state toggling burst for a network interface 130 in response to the observed toggling event count being greater than the toggling event count threshold.

The dampening engine 134 dampens network activity for network interfaces 130 for which link state toggling bursts have been detected. In an example, the dampening engine 134 may dampen network activity for a particular network interface 130 by disabling the network interface 130 for a continuous time period that is referred to herein as a “recovery window.” In this context, “disabling” a network interface generally refers to performing an action to deactivate the network interface so that the network interface does not respond to signaling via the associated communication link. In an example, the dampening engine 134 may disable a network interface 130 by causing an operating system command (e.g., an “ifconfig” command with a down flag for the LINUX operating system) to be executed on the network device 114-1 to deactivate the network interface 130. Disabling a network interface 130 transitions the associated link state to a link down state and correspondingly results in a link down state for the corresponding end device 150, which means the end device 150 cannot toggle the link state during the recovery window.

At the end of a recovery window for a particular network interface 130 (e.g., in response to a recovery window timeout), the dampening engine 134 enables (or “re-enables”) the network interface 130. In this context, “enabling” or “re-enabling” a network interface generally refers to performing an action to cause the network interface to respond to signaling over the associated communication link. In an example, the dampening engine 134 may enable a network interface 130 by causing the network device 114-1 to execute an operating system command (e.g., an “ifconfig” command with an up flag for the LINUX operating system) to activate the network interface 130. Re-enabling a network interface 130 allows the corresponding end device 150 to toggle the link state once again. If the end device 150, after a network interface 130 is re-enabled, toggles the link state at a rate that is considered to be commensurate with a link state toggling burst, then the dampening engine 134 may again disable the network interface 130 and begin another recovery window.

The dampening engine 134, in accordance with example implementations, may vary the recovery window durations so that different network interfaces 130 that are subjected to link state toggling bursts are disabled for different time periods. In an example, as further described herein, the dampening engine 134 may include a random number generator, which selects a random duration for each recovery window, within certain constraints. In another example, as further described herein, the dampening engine 134 may include a pseudorandom number generator, which selects a pseudorandom duration for each recovery window within certain constraints.

By varying the recovery window durations, the dampening engine 134 spreads out the times at which end devices 150 are re-enabled. This may be particularly advantageous when multiple network interfaces 130 of the network device 114-1 are concurrently subjected to link state toggling bursts. For example, the network device 114-1 may be connected to a large number of end devices 150 whose activities are coordinated. In an example, a large number (e.g., tens or even hundreds) of end devices 150 may be connected to the network device 114-1 and may power up at the same time. In an example, the end devices 150 may be powered through an infrastructure that is partially shut off during certain days or hours and which provides power to the end devices according to a certain schedule. Because the end devices 150 power up at or near the same time, the network device 114-1 may be incapable of timely servicing the end devices 150. Moreover, due to additional factors, such as the end devices 150 undergoing DHCP timeouts, without the dampening by the dampening engine 134, the network device 114-1 may be incapable of authenticating most of the end devices 150 regardless of the amount of time.

In an example, the end devices 150 may initially power up at about the same time, such that the power up times are spread out over a time interval less than a second. For implementations described herein in which the dampening engine 134 randomly or pseudorandomly selects the recovery window durations, the dampening engine 134 re-enables the end devices 150 at times that are spread out over seconds or tens of seconds (e.g., the re-enablement times may be distributed over a range that is at least a factor of ten or more of the range of the power-up times). In an example, as described further herein, the dampening engine may randomly or pseudorandomly select the recovery window durations from a particular large time range (e.g., a range of hundreds of seconds). The distribution of the selected recovery window durations may be or approach a uniform distribution that has significantly larger spread than the spread of the power-up times of the end devices 150. Here, the “spread” of times refers to a characterization of the dispersion of the times, such as a variance, a standard deviation, an interquartile range, or other statistical measure. The relatively large spread of the recovery window durations, in turn, spreads out the re-enablement times of the network interfaces 130. This reduces the number of end devices 150 that are concurrently being authenticated at any one time by the network device 114-1.

Among its features, the central server 176 may include one or multiple NMS engines 180 that provide one or multiple corresponding NMS services 189. In an example, through an NMS service 189, a network administrator may configure the network devices 114. For example, a network administrator may configure one or multiple configurable parameters that are used by the dampening engine 134 of the network device 114-1. In an example, a configurable parameter may be a maximum recovery window duration. In another example, a configurable parameter may be a minimum recovery window duration. In another example, configurable parameters may include a list, or pool, of candidate recovery window durations that may be selected by the dampening engine 134. In another example, a configurable parameter may be a monitoring window duration. In another example, a configurable parameter may be a toggling event count threshold that is used by the dampening engine 134 to identify link state toggling bursts.

In accordance with some implementations, a network administrator may input configuration data (including data representing configurable parameter(s) used by the dampening engine 134) via an administrative dashboard. In an example, the dashboard may be a graphical user interface (GUI) 167 that is provided by an administrative node 165 that is coupled to the network fabric 164. In an example, the GUI 167 may be provided by specific client software that is executed on the administrative node 165 or, as another example, may be provided by an Internet browser that executes on the administrative node 165. An administrative dashboard, such as the GUI 167, may, in general, provide user access to a suite of NMS services 189 for managing various aspects of an NMS cluster 112.

In addition to providing configuration services, the NMS services 189 may provide a wide variety of services to manage the network devices 114. In an example, an NMS service 189 may schedule and initiate firmware upgrades on managed network devices 114. In another example, one or multiple NMS services 189 may be used to visualize, analyze, log, collect query and/or monitoring network telemetry metrics that are reported by the network devices 114. In another example, an NMS service 189 may identify potential or actual network device failure issues based on network telemetry metric values. In another example, an NMS service 189 may identify potential or actual network performance issues (e.g., issues with a network device or a subnet) based on network telemetry metric values. In another example, an NMS service 189 may oversee remedial actions to correct network issues. In another example, an NMS service 189 may identify performance issues with a customer device (e.g., a server) that is connected to or part of the network device deployment 118. In another example, an NMS service 189 may log network events and maintain one or multiple corresponding logs. In another example, an NMS service 189 may serve responses to queries related to obtaining information about the network device deployment 118. In another example, an NMS service 189 may provide a recommended solution for an identified network issue. In an example, a recommendation may be a suggested reconfiguration, upgrade, or replacement for one or multiple network devices 114. In another example, a recommendation may be a suggested reconfiguration of a particular network subnet. In another example, a recommendation may be a suggested firmware upgrade for a particular network device 114 or group of network devices 114.

In accordance with some implementations, the central server 176 includes one or multiple nodes 188 that execute machine-readable instructions (or “software”). In the context that is used herein, a “node” refers to a processor-based entity that has an associated set of hardware and software resources. As depicted in FIG. 1, a node 188 may have one or multiple associated hardware processors 190 (e.g., one or multiple central processing unit (CPU) cores and/or one of multiple graphical processing unit (GPU) cores) and an associated memory 192. In accordance with some implementations, the memory 192 may store machine-readable instructions that, when executed by one or multiple hardware processors 190, cause the hardware processor(s) 190 to form instances of components of the activate server 174 and the central server 176. In an example, the memory 192 may store machine-readable instructions that, when executed by one or multiple hardware processors 190 cause the hardware processor(s) 190 to form an instance of an NMS engine 180. In other examples, the memory 192 may store machine-readable instructions that, when executed by one or multiple hardware processors 190 cause the hardware processor(s) 190 to form one or multiple other NMS engines 184.

In accordance with example implementations, a node 188 may be an actual, or physical, entity, such as a computer platform or a part (e.g., a part corresponding to a group of CPU cores or CPU cores) of a computer platform. In examples, a computer platform may be a rack server or blade server. In another example, a node 188 may be a virtual entity that is an abstraction of physical hardware and software resources, such as a virtual machine. Depending on the particular implementation, multiple nodes 188 may be located on one or multiple virtual or physical machines. Moreover, in accordance with example implementations, nodes 188 may be distributed across virtual or physical machines that are located at different geographical locations (e.g., located in different data centers).

In addition to the central server 176, the central NMS resources 170 may include an activate server 174. In an example, when a network device 114 first connects to the network device deployment 118, a DHCP server may provide, to the network device 114, an Internet Protocol (IP) address of the activate server 174 (e.g., provide the IP address as a DHCP option). The activate server 174, among its other functions, validates the network device 114, and the activate server 174 provides, to the network device 114, upon successful validation, network artifacts (e.g., an IP address and credentials) for connecting to the central server 176.

In the context that is used herein, a “network device” refers to an actual, or physical electronic component, which enables data communication between other components. In an example, a network device 114 may be an access device. In an example, a network device 114 may be a switch that operates at the L2, or data link, layer, of the OSI model to connect components of a computer network together. In another example, a network device 114 may operate at the L3, or network, layer, of the OSI model to connect both components of a computer network together and connect computer networks together. An L3 network device performs routing between multiple computer networks. In other examples, a network device 114 may be a gateway, a multicast router, a bridge, a component of a Gen-Z or a Compute Express Link (CXL) network, a processor device, a network interface controller (NIC) or a fabric switch that includes one or multiple of the foregoing devices.

In accordance with further implementations, the network device 114 may be a computer platform. In the context that is used herein, a “computer platform” refers to a processor-based electronic device, which has an associated operating system. For the example implementation that is depicted in FIG. 1, in addition to the network interfaces 130, a network device 114-1 may include an operating system 117 and one or multiple hardware processors 116. In an example, a hardware processor 116 may include one or multiple central processing unit (CPU) processing cores. In another example, a hardware processor 116 may include one or multiple CPU packages, or sockets. In another example, a hardware processor 116 may include one or multiple graphic processing unit (GPU) processing cores. In another example, a hardware processor 116 may include one or multiple GPU packages.

The network device 114-1 may further include a system memory 124. The system memory 124 as well as other memories that are discussed herein are non-transitory storage media that may be formed from semiconductor storage devices, memristor-based storage devices, magnetic storage devices, phase change memory devices, a combination of devices of one or more of these storage technologies, and so forth. The non-transitory storage media may represent a collection of volatile memory devices and non-volatile memory devices, in accordance with example implementations.

In accordance with example implementations, a background, or daemon, program may execute on the network device 114-1 for purposes of allowing a requestor on a remote client to log into and access the network device 114-1. In an example, the daemon program may be a secure shell daemon (SSHd) server that communicates with a remote SSH client. In accordance with some implementations, remote clients associated with the NMS services 189 may access the network device 114-1 for purposes of performing any of the functions described herein, including configuring parameters of the network device 114-1 that are used by the dampening engine 134.

As used herein, an “engine” can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An “engine” can refer to a combination of one or more hardware processing circuits and machine-readable instructions (software and/or firmware) executable on the one or more hardware processing circuits. In an example, the dampening engine 134 may be formed by one or multiple hardware processors 190 of the network device 114-1 executing machine-readable instructions 125 that are stored in the memory 124. In an example, in accordance with some implementations, the instructions 125 that are executed to form the dampening engine 134 may be firmware instructions. In another example, the dampening engine 134 may be formed in whole or in part by a PLD, ASIC, FPGA or other hardware of the network device 114-1.

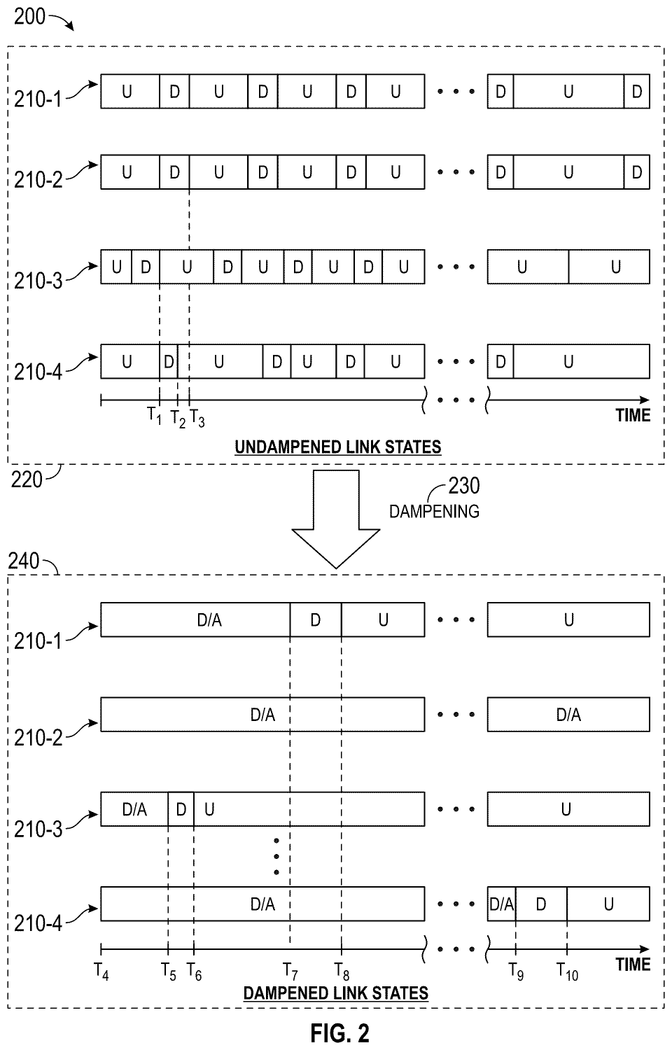

FIG. 2 is an illustration 200 of link state toggling dampening in accordance with example implementations. Referring to FIG. 2, example network interfaces of a network device (e.g., a switch) may experience observed undampened link states 220. More specifically, FIG. 2 depicts link states 210-1, 210-2, 210-3 and 210-4 for four respective network interfaces of the network device. In FIG. 2, a link up state is represented by “U,” and a link down state is represented “D.” For this example, respective end devices that are connected to the network interfaces of the network device are powered up at or near the same time.

Although for clarity FIG. 2 depicts link states for four network interfaces, the number of end devices and corresponding network interfaces may be in the hundreds. Accordingly, the network device may initially encounter the task of servicing hundreds of end devices for such purposes as authenticating the end devices. Without the link state toggling dampening, the network device may be incapable of servicing all of the end devices.

As depicted in FIG. 2, at time T₁, the link state 210-3 has a link down state-to-up state toggling event due to a DHCP timeout of the corresponding end device. The DHCP timeout by be attributable to the end device not receiving an IP address within a certain time period. In an example, the network device may perform L2authentication, and the network device may block DHCP communications for an end device until the network device authenticates the end device. Due to the large number of end devices powering up at or near the same time, the network device may, however, be unable to authenticate many (e.g., a majority) of the end devices during their initial DHCP timeout periods. Moreover, the end devices restarting their respective DHCP timeout periods by toggling the link state does not solve the problem, as other end devices may timeout and toggle their link states at or about the same time. This is illustrated in FIG. 2 by the toggling of the link state 210-4 at time T₂ and the toggling of the link states 210-1 and 210-2 at time T₃. It is assumed that for the example depicted in FIG. 2, the link states 210-1, 210-2, 210-3 and 210-4 correspond to respective link state toggling bursts.

The network device for this example has a dampening engine, such as the dampening engine 134 (FIG. 1), which performs dampening 230 to transform the undampened links states 220 into dampened link states 240. The dampening 230 selectively disables the network interfaces corresponding to the link states 210-1, 210-2, 210-3 and 210-4 for respective recovery windows. A network interface being disabled is represented in FIG. 2 by “D/A,” and corresponds to the link state being down. Although the dampening engine may disable the network interfaces at about the same time (due to the end devices being powered up simultaneously or near simultaneously), the dampening engine varies the durations of the recovery windows. This recovery window duration variation, in turn, provides more time for the network device to authenticate the end devices.

For example, at time T₅, the recovery window for the network interface corresponding to the link state 210-3 ends, and the network interface is re-enabled. The end device may then toggle the link state, as depicted at time T₆, for purposes of restarting the authentication. The recovery window duration for this network interface is the shortest for this example, and at time T₆, the other three network interfaces are still disabled, as the corresponding recovery windows are still active.

The recovery window for the network interface corresponding to the link state 210-1 has the next shortest duration for this example. At time T₇, the recovery window ends, and the network interface is re-enabled. The end device may then toggle the link state, as depicted at time T₈, for purposes of restarting the authentication. As depicted in FIG. 2, the restarting of the authentications for the network interfaces 210-1 and 210-3 is separated by more time (T₈-T₆) than the time separation of the authentication restarts for the undampened link states 220.

The recovery window for the network interface corresponding to the link state 210-4 has the third shortest duration for this example. At time T₉, the recovery window ends, and the network interface is re-enabled. The end device may then toggle the link state, as depicted at time T₁₀, for purposes of restarting the authentication. The recovery window for the network interface corresponding to the link state 210-2 has the longest duration and extends beyond the time that is depicted in FIG. 2.

As illustrated in FIG. 2, dampening 230 spreads the times at which the end devices restart authentication farther apart than the spread of these times before dampening. Stated differently, the times at which the end devices power up have a corresponding time distribution, the times at which the recovery windows end have a second time distribution, and the spread of the second time distribution is greater than the spread of the first time distribution.

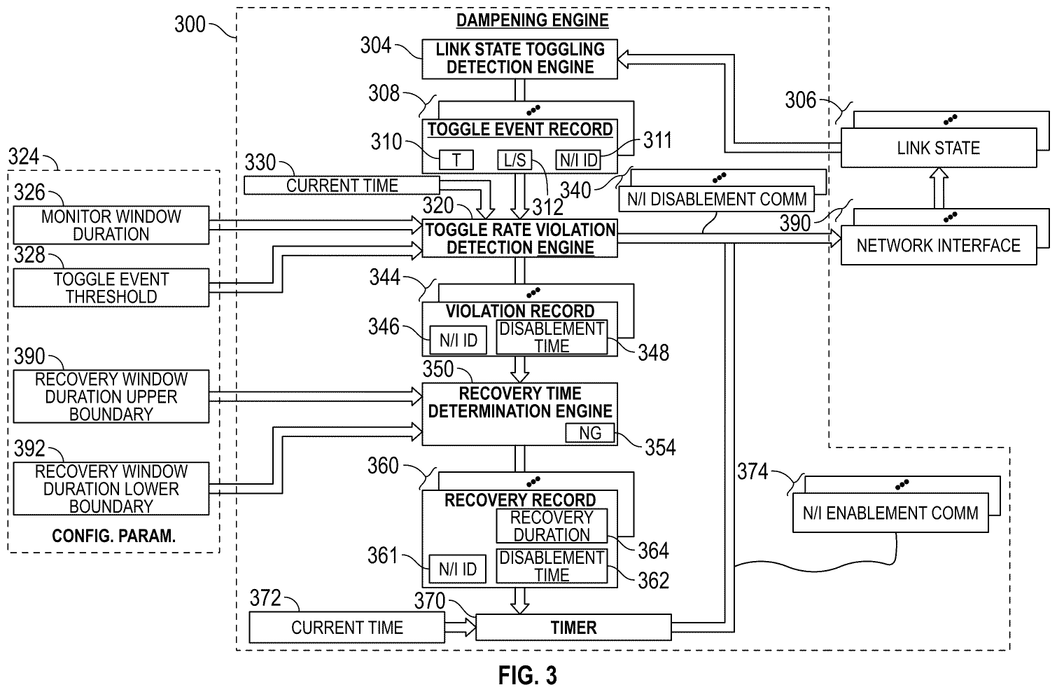

FIG. 3 depicts a dampening engine 300 and network interfaces 390, in accordance with example implementations. The dampening engine 300 and the network interfaces 390 may be part of the same network device. The dampening engine 300 is an example of the dampening engine 134 of FIG. 1. The network interfaces 130 of FIG. 1 are examples of the network interfaces 390. The network interfaces 390 have associated link states 306.

Referring to FIG. 3, in accordance with example implementations, the dampening engine 300 includes a link state toggling detection engine 304. The link state toggling detection engine 304 observes the link states 306 and detects link state change, or toggle, events. In accordance with example implementations, the link state toggling detection engine 304 generates a toggling event record 308 for each link state toggling event.

The toggling event record 308 contains data that represents the corresponding link state toggling event. In an example, a toggling event record 308 may include data 310 that represents a timestamp, or time, of the corresponding link state toggling event and data 312 representing the link state that results from the link state toggling event. In another example, the data 312 may alternatively represent the link state before the corresponding link state toggle. The toggling event record 308 may further include data 311 that represents an identification of the network interface that is associated with the link state toggle.

In an example, the link state toggling detection engine 304 may detect link up state-to-link down state toggling events, and the toggling event records 308 correspond to these events. In another example, the link state toggling detection engine 304 may detect link down state-to-link up state toggling events, and the toggling event records 308 correspond to these events. In another example, the link state toggling detection engine 304 may detect all link state toggling events, and the corresponding generated toggling event records 308 represent information about all link state toggling events.

In accordance with example implementations, the dampening engine 300 includes a toggle rate violation detection engine 320. The toggle rate violation detection engine 320, in accordance with example implementations, processes the toggling event records 308 for purposes of detecting toggle rate violations. Here, a “violation” refers to an instance of an observed time-rate of toggling events corresponding to a time-rate associated with a link state toggling burst. In accordance with example implementations, the toggle rate violation detection engine 320 applies a sliding monitor window to the toggling event records 308. In an example, the monitor window duration corresponds to a continuous interval of time spanning backwards from the current time 330 by a monitor window duration 326. In an example, the toggle rate violation detection engine 320 counts the number of link state toggling events for a particular network interface occurring during the monitoring window and compares the observed count to a threshold count 328. Based on this comparison, the toggle rate violation detection engine 320 may then determine whether the corresponding network interface 390 has experienced a link state toggling burst, or toggle rate violation. As depicted in FIG. 3, in accordance with some implementations, the monitor window duration 326 and the toggling event count 328 may be defined by corresponding configuration parameters 324.

In accordance with example implementations, the toggle rate violation detection engine 320, in response to detecting a toggle rate violation, disables the corresponding network interface 390. FIG. 3 depicts a network interface disablement communication 340 for this purpose. In an example, a network interface disablement communication 340 may correspond to the toggle rate violation detection engine 320 issuing a command (e.g., an operating system command, such, for LINUX, an “ifconfig” command with a down flag) to disable the network interface 390.

In addition to disabling network interfaces 390 that have corresponding toggle rate violation detections, the toggle rate violation detection engine 320, in accordance with example implementations, generates violation records 344. The violation record 344, in accordance with example implementations, corresponds to a particular network interface 390 that has experienced a link state toggling burst. In accordance with example implementations, the violation record 344 includes data 346 that identifies the network interface 390. Moreover, the violation record 344 may include additional data, such as data 348 that represents a disablement time. Here, the disablement time represents the time at which the corresponding recovery window began.

As depicted in FIG. 3, in accordance with example implementations, a recovery time determination engine 350 of the dampening engine 300 determines a duration for each recovery time window. In an example, for this purpose, the recovery time determination engine 350 may include a number generator 354, which generates a value or number that represents a duration for a recovery time window.

In accordance with example implementations, the number generator 354 may be a non-deterministic random bit generator (NRBG) (also called a “true random bit generator” or “true random number generator”), which generates a bit string or other number representation that exhibits full entropy. The number provided by the number generator 354 may be referred to as a “random number.” In an example, the number generator 354 may include an analog-to-digital (ADC) converter that receives an analog input from an entropy source and converts the input into a digital value or bit sequence that represents a random number. In examples, the entropy source may be a thermal noise signal (e.g., a Johnson-Nyquist noise signal that is provided by a resistor), an atmospheric noise signal that is received by an antenna, a signal representing clock variations, a signal representing air movement, or other source that exhibits full entropy. In an example, the entropy source may be the same or similar to any of the entropy sources that are described in “Recommendation for the Entropy Sources Used for Random Bit Generation,” National Institute of Standards and Technology (NIST) Special Publication (SP) 800-90B (January 2018). In an example, the number generator 354 may have a design the same as or similar to any of the designs that are described in “Recommendation for Random Bit Generator (RBG) Constructions,” NIST SP 800-90C Third Public Draft (September 2022).

In accordance with further example implementations, the number generator 354 may be a pseudorandom generator, which generates bit sequences or other number representations (called “pseudorandom number”) that are not truly random. In an example, number generator 354 may be a deterministic random bit generator (DRNG) that generates a pseudorandom number from a seed. In an example, the seed may be provided by an entropy source, such as any of the entropy sources described herein. In another example, the seed may be provided by a source other than an entropy source, such as, for example, a clock or a counter. In an example, the number generator 354 may have a design the same as or similar to any of the designs that are described in “Recommendation for Random Number Generation Using Deterministic Random Bit Generators,” NIST SP 800-90A Rev. 1 (June 2015). In another example, the number generator 354 may be a pseudorandom generator, which applies a polynomial function to a seed for purposes of generating a pseudorandom number.

In accordance with some implementations, the recovery time determination engine 350 may constrain the recovery window duration to be within a certain range. For example, the range may be specified by a lower boundary, or limit, for the range and further specified by an upper boundary, or limit, for the range. In an example, a lower limit and/or an upper limit may be specified by a configuration parameter of the network device. In another example, both the upper and lower limits for the recovery window duration may be specified by respective configuration parameters of the network device.

In an example, the network device may impose a constraint that a selectable lower limit, or lower boundary, for the recovery interval is to be a time between 30 to 60 seconds. In an example, the network device may impose a constraint that a selectable upper limit, or upper boundary, for the recovery interval is to be a time between 180 and 600 seconds. In an example, if it assumed that the network device is configured with a lower boundary of 60 seconds and an upper boundary of 180 seconds, then the number generator 354 is constrained to select recovery window duration in the time interval [60, 180].

The number generator 354 may constrain the recovery window duration within a range in any of a number of different ways. In an example, the number generator 354 may select a particular recovery window duration (called “RW_{DURATION}”) as described below:

$${RW}_{DURATION} = MOD ( Rand ( ) , {RW}_{UB} - {RW}_{LB} + 1 ) + {RW}_{LB} , \qquad Eq . 1$$

where “RW_{UB}” represents the upper boundary for the recovery window; “RW_{LB}” represents the lower boundary for the recovery window; “Rand( )” represents a pseudorandom or random function; and “MOD( )” represents a modulo function that returns a remainder of Rand( ) divided by “RW_{UB}—RW_{LB}+1.”

In another example, the number generator 354 may be configured (e.g., configured by configuration parameters of the network device) with a list of numbers that correspond to durations (e.g., seconds) within the time interval defined by upper and lower boundaries for the recovery window duration. In this manner, the number generator 354 may select a number (corresponding to a recovery window duration) from the list. In an example, the number generator 354 may cycle through a list of numbers (that correspond to durations within a particular range) according to a particular sequence index so that the number that is generated depends on the current value of the sequence index. In an example, the number generator 354 may randomly select a number from a pool of numbers that correspond to durations within a particular range. In another example, the number generator 354 may pseudorandomly select a number from a pool of numbers that correspond to durations within a particular range.

As depicted in FIG. 3, in accordance with example implementations, the recovery time determination engine 350 generates recovery records 360. A recovery record 360, in accordance with example implementations, contains data that corresponds to a particular network interface 390 that has experienced a link state toggling burst and contains data representing information about the corresponding recovery window. In an example, a recovery record 360 may include data 361 representing an identification of the network interface 390 and data 362 representing the time at which the network interface 390 was disabled. Moreover, the recovery record 360 may further include data 364 that represents a duration of the recovery window determined by the recovery time determination engine 350.

A timer 370 of the dampening engine 300, in accordance with example implementations, processes the recovery records 360 for purposes of measuring the corresponding recovery windows. The timer 370, in accordance with example implementations, measures each recovery duration and generates a timeout indication to represent expiration of the recovery duration. In this manner, the timer 370 may, for example, add the recovery window duration to the disablement time to set an end time and generate a timeout in response to the current time 372 reaching the end time. The timer 370, in accordance with example implementations, may, in response to a recovery window timeout, initiate a corresponding network interface enablement communication 374 for purposes of enabling the corresponding network interface 390. In an example, the network interface enablement communication 374 may correspond to an operating system command (e.g., an operating system command, such as, for LINUX, an “ifconfig” command with an up flag) to re-enable the network interface.

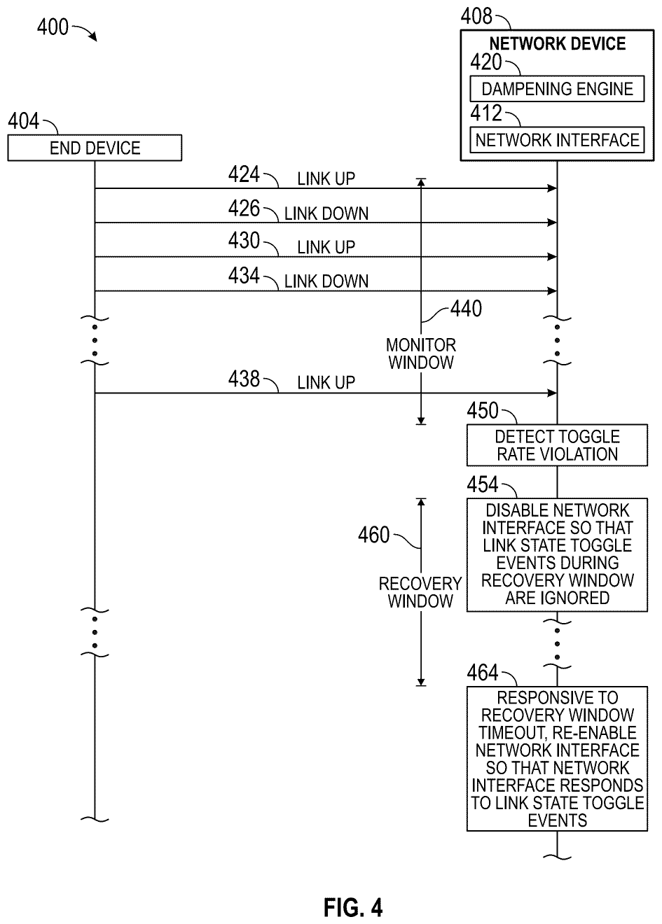

FIG. 4 is a sequence flow diagram 400 depicting actions taken by a network device 408 to detect a link state toggling burst and inhibit a response of the network device to network activity associated with the link state toggling burst. The network device 114-1 of FIG. 1 is an example of the network device 408. For this example, the network device 408 includes a network interface 412 that experiences a link state toggling burst, and the network device 408 includes a dampening engine 420. The dampening engine 420, as described herein, detects the link state toggling burst and controls the disabling and re-enabling of the network interface 412 in response thereto.

An end device 404 may be coupled to the network interface 412 by a corresponding wired communication link. For this example, the dampening engine 420 monitors the link state associated with the network interface 412 over a monitoring window 440. During the monitoring window, the end device 404 toggles the link state. For the example depicted in FIG. 4, the end device 404 brings up the link state, as depicted at 424, 434 and 438 and brings down the link state, as depicted at 426 and 434. Moreover, for this example, the dampening engine 420, based on a count of link state toggling events occurring during the monitoring window 440, detects a toggle rate violation, as depicted at 450. The dampening engine 420, in response to detecting the link state toggle rate violation, disables the network interface 412, as depicted at 454, to begin a corresponding recovery window 460.

For the duration of the recovery window 460, the network interface 412 is disabled so that link toggling events during the recovery window 460 are ignored by the network device 408. As depicted at 464, responsive to the timeout, or end, of the recovery window, the dampening engine 420 re-enables the network interface 412 so that the network interface 412 responds to link toggle state toggling events.

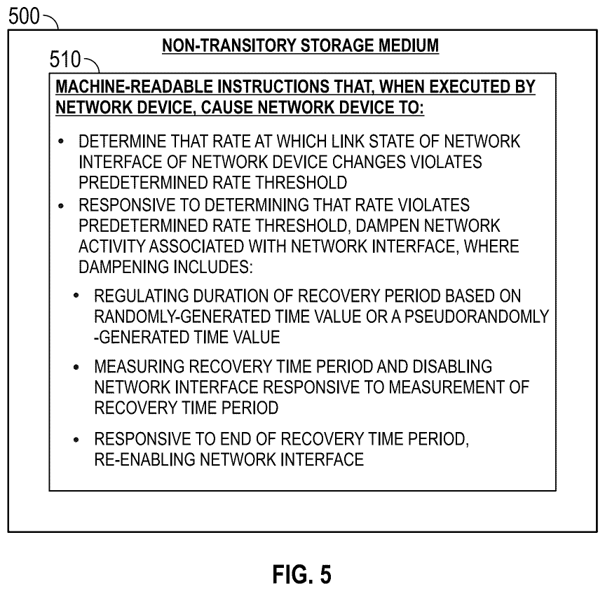

Referring to FIG. 5, in accordance with example implementations, a non-transitory storage medium 500 stores machine-readable instructions 510 that, when executed by a network device, cause the network device to determine that a rate at which a link state of a network interface of the network device changes violates a predetermined rate threshold. In an example, the network device may be a switch. In an example, the network device may be an L2 device. In an example, the network device may be an L3 device. In an example, the network device determines a rate that the link state changes based on a count of the changes over a monitoring window. In an example, the changes may be link down state-to-link up state toggles. In an example, the changes may be link up state-to-link down state toggles. In an example, the changes may be link down state-to-link up state toggles. In an example, the changes may be link up state-to-link down state toggles and link down state-to-link up state toggles. In an example, the instructions may correspond to firmware of the network device.

In an example, an end device may violate the predetermined due to malevolent software executing on the end device in furtherance of a security attack on the network. In an example, an end device may violate the predetermined due to the end device being simultaneously or near simultaneously being powered up with other end devices that are connected to network interfaces of the network device.

In an example, the network device may timestamp link state toggling events. In an example, the network device may generate a record for a link state toggling event, and the record may contain data representing a time of the event.

The instructions 510, when executed by the network device, further cause the network device to, responsive to determining that the rate violates the predetermined rate threshold, dampen network activity associated with the network interface. The dampening includes regulating the duration of a recovery time period based on a randomly-generated time value or a pseudorandomly-generated time value. In an example, regulating the duration includes using a DRNG to generate a pseudorandom time value. In an example, using the DRNG includes acquiring a seed generated by an entropy source. In another example, regulating the duration includes using an RNG to generate a random time value. In an example, regulating the duration includes constraining the duration to a configurable lower boundary. In an example, regulating the duration includes constraining the duration to a configurable upper boundary.

The dampening includes measuring the recovery time period and disabling the network interface responsive to the measurement of the recovery time period. In an example, measuring the recovery time period includes using a timer. The dampening includes disabling the network interface responsive to the measuring of the recovery time period. In an example, the network interface may be disabled by executing an operating system command. In an example, the network interface may be disabled by executing an ifconfig command with a down flag. The dampening includes, responsive to an end of measuring the recovery period, re-enabling the network interface. In an example, the network interface may be re-enabled by executing an operating system command. In an example, the network interface may be re-enabled by executing an ifconfig command with an up flag.

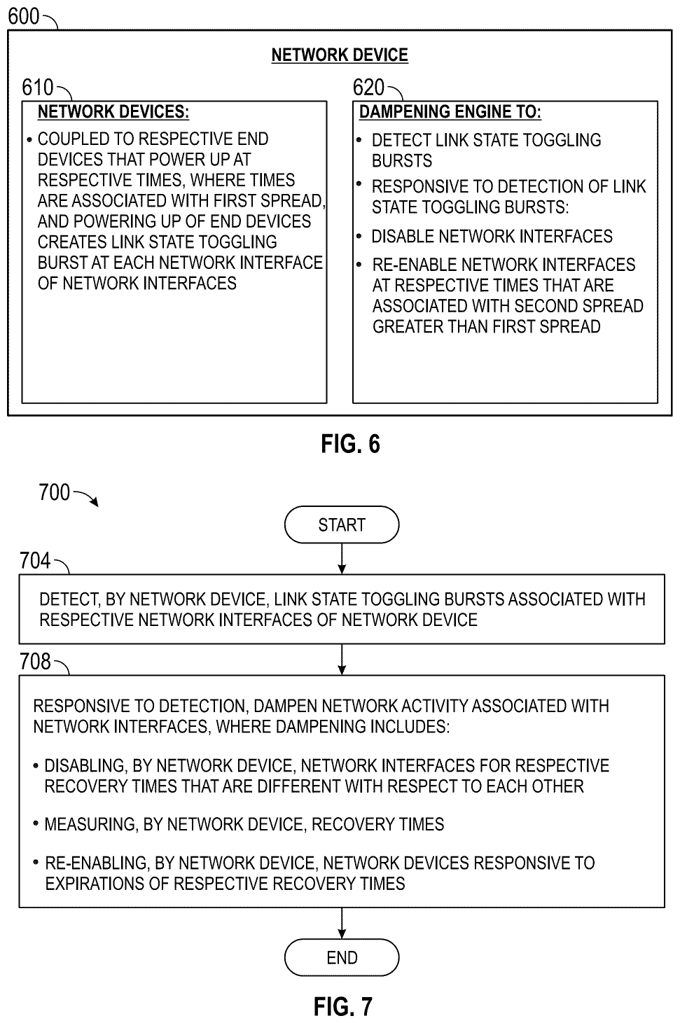

Referring to FIG. 6, in accordance with example implementations, a network device 600 includes network interfaces 610 and a dampening engine 620. In an example, the network interfaces 610 may correspond to network endpoints. In an example, the dampening engine 620 may correspond to machine-readable instructions being executed by a hardware process. In an example, the dampening engine 620 may correspond to a PLD, an ASIC or a FPGA. In an example, the network device 600 may be a switch. In an example, the network device 600 may be an L2 device. In an example, the network device 600 may be an L3 device.

The network interfaces 610 are coupled to respective end devices that power up at respective times. The times are associated with a first spread, and the powering up of the end devices creates a link state toggling burst at each network interface. In examples, an end device may be an IoT device, a camera, a sensor, computers, a server, a client, a laptop, printer, a scanner, a digital copier, a gaming machine, or any other processor-based device.

The dampening engine 620 detects the link state toggling bursts. In an example, the dampening engine detects a link state toggling burst by comparing a time-rate that a link state changes to a pre-defined rate threshold. In an example, the changes may correspond to down-to-up link state toggling events. In an example, the changes may correspond to up-to-down link state toggling events. In an example, the changes may correspond to up-to-down link state toggling events and down-to-up link state toggling events. In an example, the comparing the time-rate that the link state changes to the predefined threshold includes comparing a count of link state changes over a monitoring window to a count threshold.

The dampening engine, responsive to the detection of the link state toggling bursts, disables the network interfaces. The dampening engine, responsive to the detection of the link state toggling bursts, re-enables the network interfaces at respective times that are associated with a second spread that is greater than the first spread. The second spread being greater than the first spread may be the result of applying any of a number of statistical measures, such as a comparison of variances, standard deviations, interquartile ranges, or other statistical measures. In an example, the network interface may be disabled by executing an ifconfig command with a down flag. In an example, the network interface may be re-enabled by executing an ifconfig command with an up flag.

Referring to FIG. 7, in accordance with example implementations, a technique 700 includes detecting (block 704), by a network device, link state toggling bursts that are associated with respective network interfaces of the network device. In an example, the network device may be a switch. In an example, the network device may be an L2 device. In an example, the network device may be an L3 device. In an example, the network detects a link state toggling burst by comparing a time-rate that a link state changes to a pre-defined rate threshold. In an example, the changes may correspond to down-to-up link state toggling events. In an example, the changes may correspond to up-to-down link state toggling events. In an example, the changes may correspond to up-to-down link state toggling events and down-to-up link state toggling events. In an example, the comparing the time-rate that the link state changes to the predefined threshold includes comparing a count of link state changes over a monitoring window to a count threshold.

The technique 700 includes, responsive to the detection, dampening (block 708) a responsiveness of the network device to network activity associated with the link state toggling bursts. Dampening the responsiveness includes disabling, by the network interface, the network interfaces for respective recovery times that are different with respect to each other and measuring, by the network device, the recovery times. The dampening includes re-enabling, by the network device, the network devices responsive to expirations of the respective recovery times.

In accordance with example implementations, the changes include a change corresponding to a transition of the link state from a link down state to a link up state. Among the advantages, the dampening inhibits end devices from being denied network-provided services.

In accordance with example implementations, the changes include a change corresponding to a transition of the link state from a link up state to a link down state. Among the advantages, the dampening inhibits end devices from being denied network-provided services.

In accordance with example implementations, a first count of transitions of the link state occurring during a monitoring window, and the first count is compared to a pre-defined threshold count. A determination is made that the rate violates the predetermined rate threshold responsive to the comparison. Among the advantages, the dampening inhibits end devices from being denied network-provided services.

In accordance with example implementations, the first count and the predefined count threshold are read from configuration data of the network device. Among the advantages, the dampening inhibits end devices from being denied network-provided services.

In accordance with example implementations, the respective times distributed according to the first time distribution extend over a first range, and the respective times distributed according to the second time distribution extend over a second range that is at least a factor of ten larger than the first range. Among the advantages, the dampening inhibits end devices from being denied network-provided services.

In accordance with example implementations, identifying the first network interface having the associated sequence of link state changes that exceeds the predefined time rate threshold includes determining, by the network device, a duration of a monitoring time window; and determining, by the network device, a maximum number of link toggles for the monitoring time window. Identifying the first network interface further includes monitoring the sequence of link state changes associated with the first network interface for the duration of the monitoring time window; and determining, by the network device, that the sequence of link state changes associated with the first network interface exceeds the predefined time rate threshold based on the duration and the maximum number of link toggles. Among the advantages, the dampening inhibits end devices from being denied network-provided services.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A non-transitory storage medium that stores machine-readable instructions that, when executed by a network device, cause the network device to:
determine that a rate at which a link state of a network interface of the network device changes violates a predetermined rate threshold; and
responsive to determining that the rate violates the predetermined rate threshold, dampen network activity associated with the network interface, wherein the dampening comprises:
measuring a recovery time period and disabling the network interface responsive to the measuring of the recovery time period;
regulating the duration of the recovery time period based on a randomly-generated time value or a pseudorandomly-generated time value; and
responsive to an end of the recovery period, re-enabling the network interface.

2. The storage medium of claim 1, wherein the network device changes comprise a change corresponding to a transition of the link state from a link down state to a link up state.

3. The storage medium of claim 1, wherein the network device changes comprise a change corresponding to a transition of the link state from a link up state to a link down state.

4. The storage medium of claim 1, wherein the instructions, when executed by the network device, further cause the network device to:
determine a first count of transitions of the link state occurring during a monitoring window;
compare the first count with a pre-defined threshold count; and
responsive to the comparison, determining that the rate violates the predetermined rate threshold.

5. The storage medium of claim 4, wherein the instructions, when executed by the network device, further cause the network device to read the first count and the predefined count threshold from configuration data of the network device.

6. A network device comprising:
network interfaces coupled to respective end devices that power up at respective times, wherein the times are associated with a first spread, and the powering up of the end devices creates a link state toggling burst at each network interface of the network interfaces; and
a dampening engine to:
detect the link state toggling bursts; and
responsive to the detection of the link state toggling bursts:
disable the network interfaces; and
re-enable the network interfaces at respective times that are associated with a second spread greater than the first spread.

7. The network device of claim 6, wherein the respective times distributed according to the first time distribution extend over a first range, and the respective times distributed according to the second time distribution extend over a second range that is at least a factor of ten larger than the first range.

8. The network device of claim 6, further comprising:
determine a first count of transitions of the link state occurring during a monitoring window;
compare the first count with a pre-defined threshold count; and
responsive to the comparison, determining that the rate violates the predetermined rate threshold.

9. The network device of claim 8, wherein the instructions, when executed by the network device, further cause the network device to read the first count and the predefined count threshold from configuration data of the network device.

10. The network device of claim 6, wherein identifying the first network interface having the associated sequence of link state changes that exceeds the predefined time rate threshold comprises:
determining, by the network device, a duration of a monitoring time window;
determining, by the network device, a maximum number of link toggles for the monitoring time window;
monitoring the sequence of link state changes associated with the first network interface for the duration of the monitoring time window; and
determining, by the network device, that the sequence of link state changes associated with the first network interface exceeds the predefined time rate threshold based on the duration and the maximum number of link toggles.

11. The network device of claim 6, wherein the dampening engine to further:
read a configuration value representing the duration of the monitoring time window; and
read a configuration value representing the maximum number of link toggles.

12. A method comprising:
detecting, by a network device, link state toggling bursts associated with respective network interfaces of the network device;
responsive to the detection, dampening network activity associated with the network devices, wherein the dampening comprises:
disabling, by the network device, the network interfaces for respective recovery times that are different with respect to each other;
measuring, by the network device, the recovery times; and
re-enabling, by the network device, the network interfaces responsive to expirations of the respective recovery times.

13. The method of claim 12, wherein varying the first duration relative to the second duration comprises randomly or pseudorandomly generating a first time value corresponding to the first duration and randomly or pseudorandomly generating a second time value corresponding to the second duration.

14. The method of claim 13, further comprising:
reading, by the network device, configuration data representing a boundary for the first time value,
wherein randomly or pseudorandomly generating the first time value comprises constraining the first time value to the boundary.

15. The method of claim 13, further comprising:
reading, by the network device, configuration data representing a minimum time value boundary and a maximum time value boundary,
wherein randomly or pseudorandomly generating the first time value comprises constraining the first time value to a range defined by the minimum time value boundary and the maximum time value boundary.

16. The method of claim 12, wherein identifying the first network interface having the associated sequence of link state changes that exceeds the predefined time rate threshold comprises:
determining, by the network device, a duration of a monitoring time window;
determining, by the network device, a maximum number of link toggles for the monitoring time window;
monitoring the sequence of link state changes associated with the first network interface for the duration of the monitoring time window; and
determining, by the network device, that the sequence of link state changes associated with the first network interface exceeds the predefined time rate threshold based on the duration and the maximum number of link toggles.

17. The method of claim 16, wherein determining the duration of the monitoring time window comprises reading, by the network device, a configuration value representing the duration of the monitoring time window.

18. The method of claim 16, wherein determining the maximum number of link toggles comprises reading, by the network device, a configuration value representing the maximum number of link toggles.

19. The method of claim 12, further comprising:
logging, by the network device, toggling events associated with a link connected to the first network interface to provide a log, wherein the logging comprises recording, for each toggling event, a record comprising data representing a time of the event and a state of the link;
wherein:
the predefined time rate threshold corresponds to a maximum number of link state changes within a monitoring time window; and
identifying the first network interface having the associated sequence of link state changes that exceeds the predefined time rate threshold comprises, based on the log and the monitoring time window, identifying the link state changes and determining that the number of the link state changes exceeds the maximum number.

20. The method of claim 19, wherein the toggling events comprise at least one of link up state-to-down state transitions or link down state-to-up state transitions.
